(19) United States
(12) Patent Application Publication
(10) Pub. No.: US 2016/0283072 A1
(43) Pub. Date: Sep. 29, 2016

(54) USER-INTERFACE CONSISTENCY-CHECKING METHOD, DEVICE AND PROGRAM

(71) Applicant: NEC SOLUTION INNOVATORS, LTD., Tokyo (JP)

(72) Inventor: Yusuke NAKAO, Tokyo (JP)

(73) Assignee: NEC SOLUTION INNOVATORS, LTD., Tokyo (JP)

(21) Appl. No.: 14/778,304

(22) PCT Filed: Jan. 10, 2014
(86) PCT No.: PCT/JP2014/000085

§ 371 Date: Sep. 18, 2015

(30) Foreign Application Priority Data
Mar. 19, 2013 (JP) 2013-056651

(51) Int. Cl. G06F 3/0484; G06F 17/30

(52) U.S. Cl. CPC G06F 3/0484; G06F 17/30905

(57) ABSTRACT

A usability-check-result output method acquires screen information on a screen to be checked, checks consistency of a user interface of the screen based on a previously-defined check rule, and displays an item not conforming to the check rule.

### TECHNICAL FIELD

The present invention relates to a user-interface consistency-checking method for checking consistency of a user interface of a screen, a user-interface consistency-checking device, and a user-interface consistency-checking program.

### BACKGROUND ART

Developed user interfaces of screens such as WEB pages may be different in their qualities depending on developers, and thus need to be checked by experts. However, there is a problem that since a number of persons who can check are limited, check takes cost and time.

NPL 1 discloses therein a tool for automatically evaluating usability such as readability on WEB page screens or understandability of contents and extracting a problem to be improved.

NPL 2 discloses therein selenium as an automated tool for testing application software.

### CITATION LIST

### Non Patent Literature

NPL 1: Takehiro, SUZUKI, “An Automatic Usability Testing Method for web pages”, master thesis, NARA INSTITUTE of SCIENCE and TECHNOLOGY, Feb. 14, 1999

NPL 2: “seleniumHQ”, [online], [searched on Feb. 28, 2013], Internet <URL:http://docs.seleniumhq.org/>

### SUMMARY OF INVENTION

### Technical Problem

However, there is a problem that the checking by the tool described in NPL 1 is limited to the checking on individual items and thus usability of an entire user interface including a plurality of items cannot be checked.

It is therefore an object of the present invention to provide a usability-check-result output method capable of checking usability of an entire user interface including a plurality of items, a user-interface consistency-checking device, and a usability-check-result output program.

### Solution to Problem

A user-interface consistency-checking method according to the present invention is characterized by acquiring screen information on a screen to be checked, checking consistency of a user interface of the screen based on a previously-defined check rule, and displaying an item not conforming to the check rule.

A user-interface consistency-checking device according to the present invention is characterized by including an input unit for acquiring screen information on a screen to be checked, a check unit for checking consistency of a user interface of the screen based on a previously-defined check rule, and a display processing unit for displaying an item not conforming to the check rule.

A user-interface consistency-checking program according to the present invention is characterized by causing a computer to perform an input processing of acquiring screen information on a screen to be checked, a check processing of checking consistency of a user interface of the screen based on a previously-defined check rule, and a display processing of displaying an item not conforming to the check rule.

### Advantageous Effects of Invention

According to the present invention, it is possible to check usability of an entire user interface including a plurality of items.

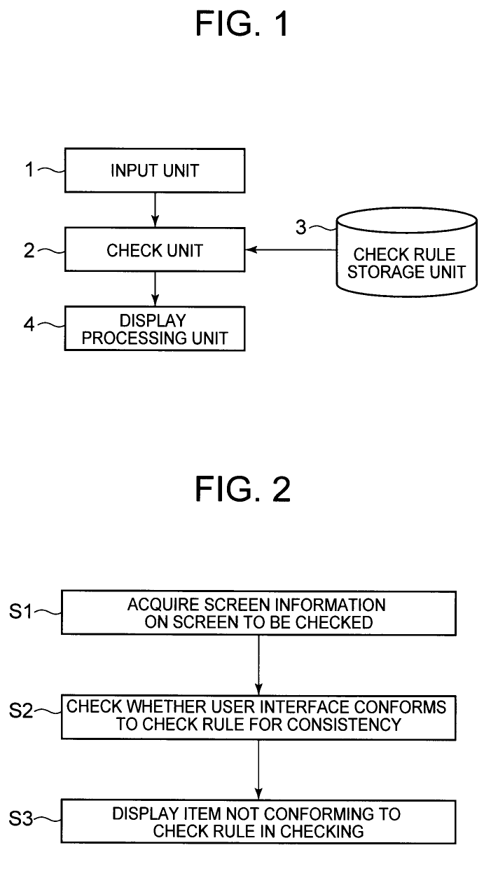

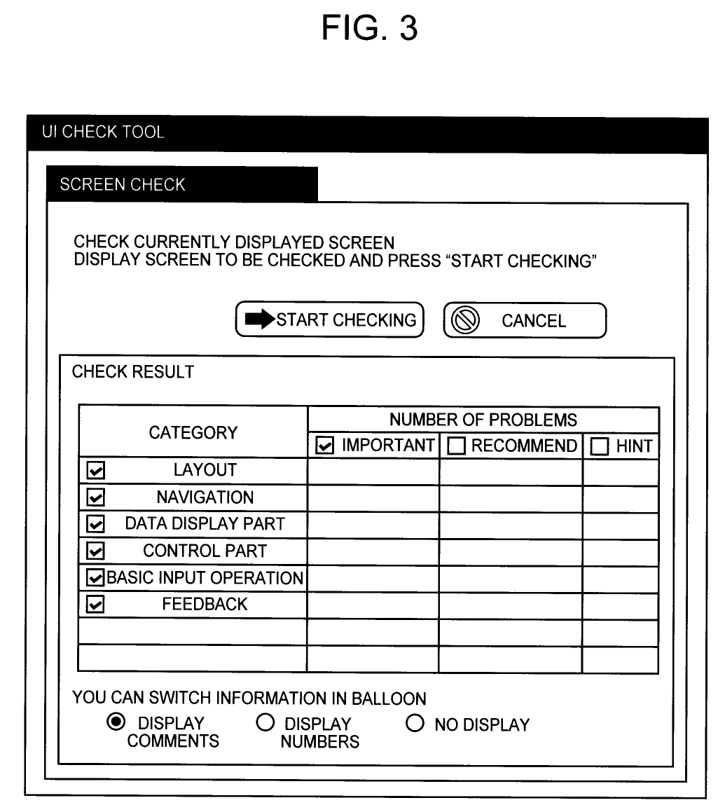

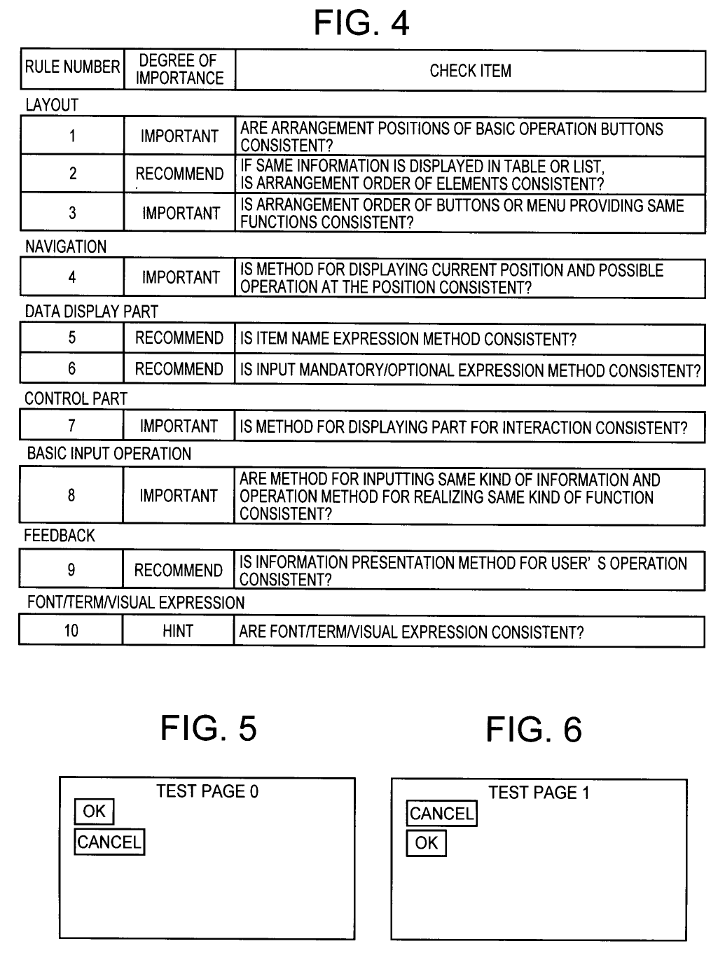

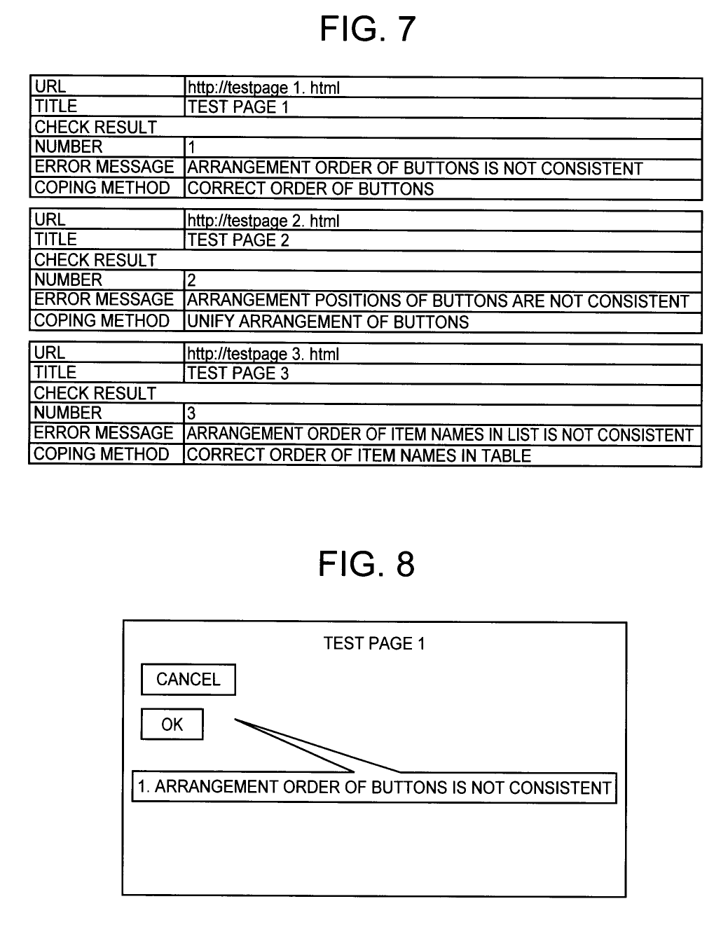

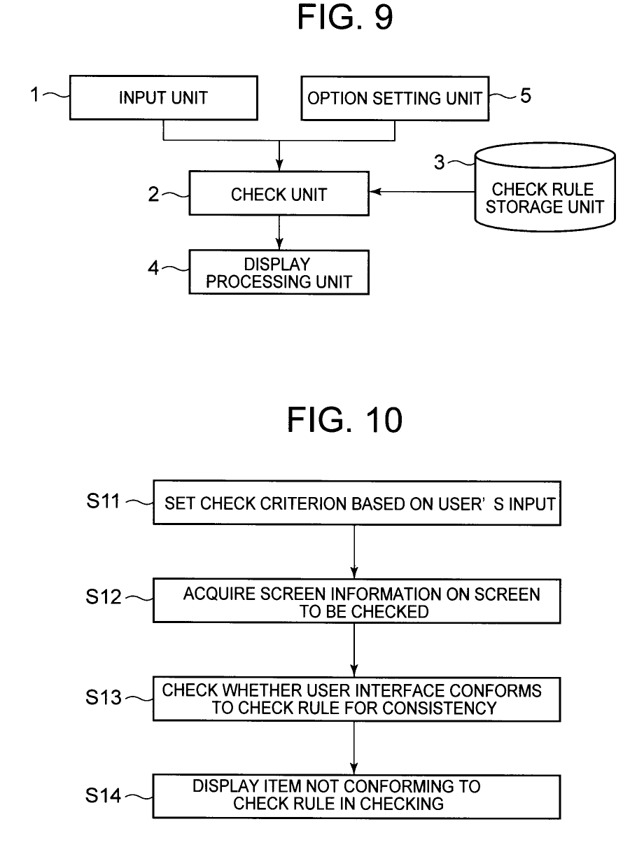

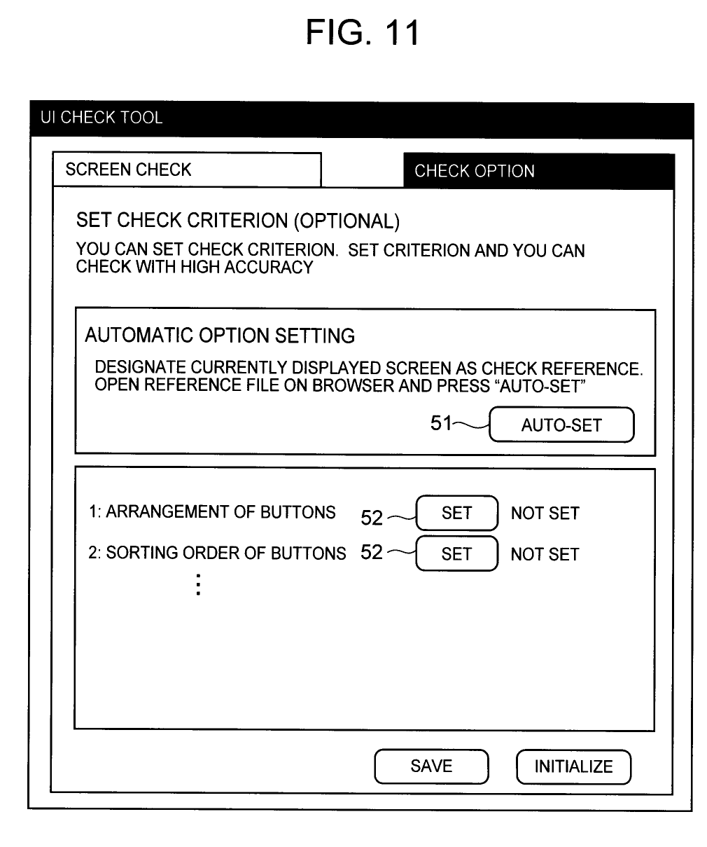

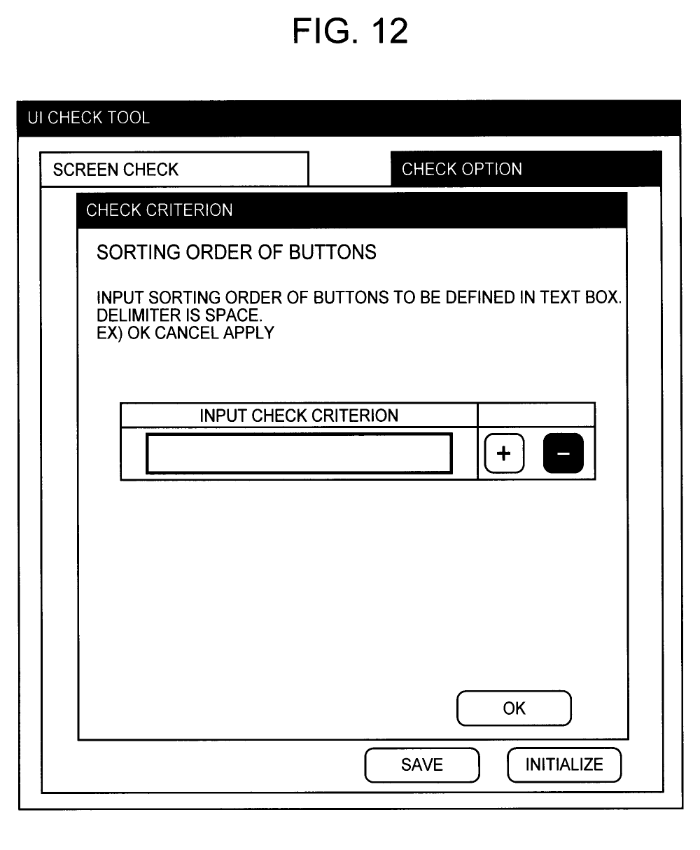

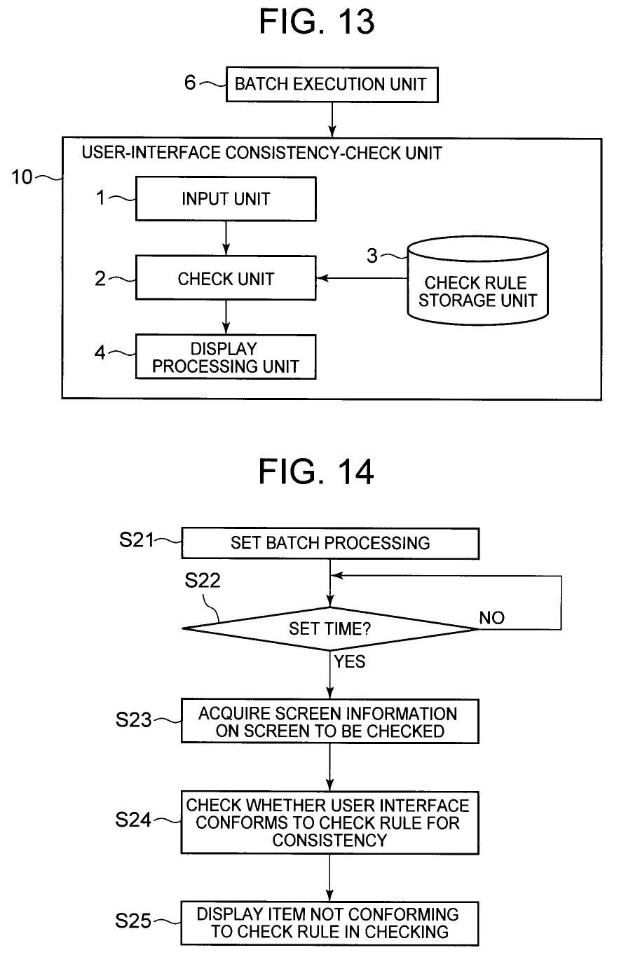

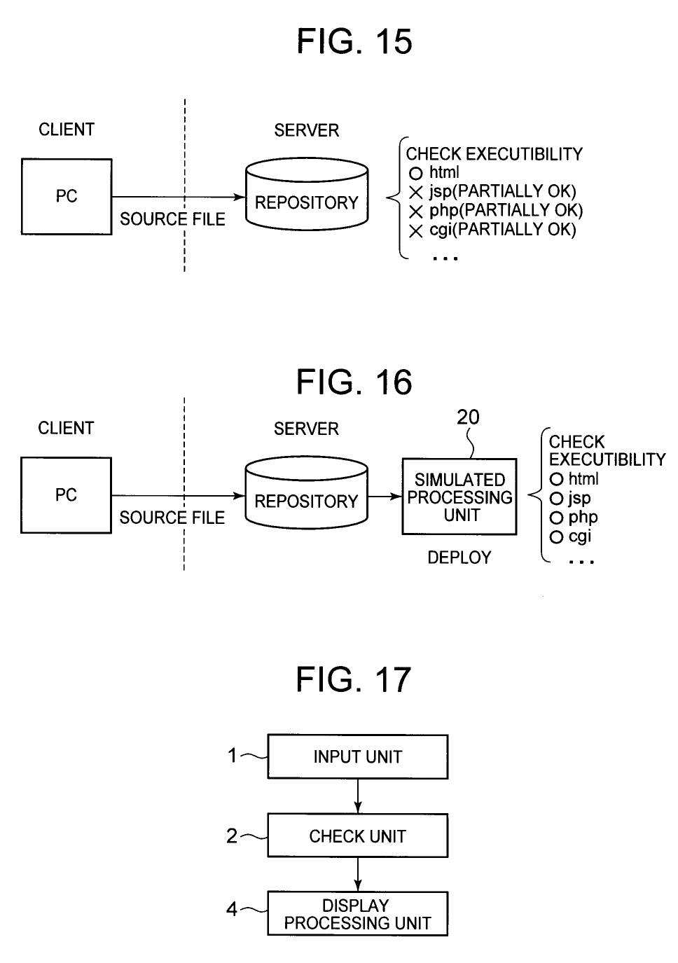

### BRIEF DESCRIPTION OF DRAWINGS

[FIG. 1] It depicts a block diagram illustrating a structure of a user-interface consistency-checking device according to a first exemplary embodiment of the present invention.

[FIG. 2] It depicts a flowchart illustrating the operations of the user-interface consistency-checking device according to the first exemplary embodiment of the present invention.

[FIG. 3] It depicts an explanatory diagram illustrating an exemplary setting screen.

[FIG. 4] It depicts an explanatory diagram illustrating exemplary check rules.

[FIG. 5] It depicts an explanatory diagram illustrating an exemplary screen arranging two buttons thereon.

[FIG. 6] It depicts an explanatory diagram illustrating another exemplary screen arranging two buttons thereon.

[FIG. 7] It depicts an explanatory diagram illustrating an exemplary screen displaying a list of check results thereon.

[FIG. 8] It depicts an explanatory diagram illustrating an exemplary screen displaying thereon a message box indicating an item not conforming to a check rule.

[FIG. 9] It depicts a block diagram illustrating a structure of a user-interface consistency-checking device according to a second exemplary embodiment of the present invention.

[FIG. 10] It depicts is a flowchart illustrating the operations of the user-interface consistency-checking device according to the second exemplary embodiment of the present invention.

[FIG. 11] It depicts an explanatory diagram illustrating an exemplary option setting screen.

[FIG. 12] It depicts an explanatory diagram illustrating an exemplary check criterion setting screen.

[FIG. 13] It depicts a block diagram illustrating a structure of a user-interface consistency-checking device according to a third exemplary embodiment of the present invention.

[FIG. 14] It depicts a flowchart illustrating the operations of the user-interface consistency-checking device according to the third exemplary embodiment of the present invention.

[FIG. 15] It depicts an explanatory diagram illustrating an exemplary batch processing.

[FIG. 16] It depicts an explanatory diagram illustrating another exemplary batch processing.

[FIG. 17] It depicts a block diagram illustrating a structure of main components in a user-interface consistency-checking device according to the present invention.

### DESCRIPTION OF EMBODIMENTS

Exemplary embodiments of a user-interface consistency-checking device according to the present invention will be described below with reference to the drawings.

FIG. 1 is a block diagram illustrating a structure of a user-interface consistency-checking device according to the present exemplary embodiment. As illustrated in FIG. 1, the user-interface consistency-checking device according to the present exemplary embodiment includes an input unit 1, a check unit 2, a check rule storage unit 3, and a display processing unit 4. The input unit 1, the check unit 2, and the display processing unit 4 are realized in hardware designed to conduct a series of specific calculation processing, or by an information processing apparatus such as CPU (Central Processing Unit) operating according to a program, for example. The check rule storage unit 3 is realized by a storage device such as typical HDD (Hard Disk Drive).

The input unit 1 acquires screen information for defining a user interface of a screen to be checked. When the screen is a WEB page displayed on a typical browser, for example, the input unit 1 acquires a HTML (HyperText Markup Language) source as screen information. Further, the input unit 1 may acquire screen information such as coordinate information, color information and text information within a displayed screen from the browser, for example. Any other screens displaying a user interface thereon, not limited to WEB pages, may be to be checked.

The check unit 2 acquires a check rule for consistency of a user interface from the check rule storage unit 3, and checks whether the screen information acquired from the input unit 1 conforms to the check rule. Specifically, when a different expression method is found in a plurality of associated items, the check unit 2 determines an inconsistent item as an error with reference to the most common expression method.

The check rule storage unit 3 stores therein the check rules for checking consistency of a user interface of a screen. The check rules are based on consistency for display and operations of a plurality of associated items, and are previously stored by a designer or the like. The check rule storage unit 3 stores error messages, supplementary messages, coping methods, and the like associated with the check rules, respectively. The check rules may be described in a program for causing the CPU to perform the operations of the check unit 2, and in this case, the check rule storage unit 3 is dispensable.

The display processing unit 4 displays a list of items not conforming to the check rules in the checking. The check results are URL, title, error number, error message, coping method, and the like of a screen including the items.

The operations of the user-interface consistency-checking device according to the present exemplary embodiment will be described below. FIG. 2 is a flowchart illustrating the operations of the user-interface consistency-checking device according to the present exemplary embodiment. At first, the user sends an instruction to cause the user-interface consistency-checking device to start checking. At this time, the display processing unit 4 may display a setting screen enabling the user to perform detailed setting for the checking. FIG. 3 is an explanatory diagram illustrating an exemplary setting screen. Specifically, the user selects a category to be checked and presses a check start button on the setting screen as illustrated in FIG. 3, for example.

The setting screen is configured such that the user can select contents to be checked depending on a degree of importance. In the example illustrated in FIG. 3, the user can select one of three types “important”, “recommend”, and “hint.” Further, the setting screen may be configured such that the user can select a type of rule to be checked. Further, as illustrated in FIG. 3, there may be configured such that when the checking described later is completed, the number of problems (the number of items not conforming to check rules) is displayed. The setting screen is configured such that the user can switch a check result display method. In the example illustrated in FIG. 3, the user can select a display method from among three types “display comments”, “display numbers”, and “no display.”

When being sent an instruction to start checking from the user, the input unit 1 acquires the screen information for defining a user interface of the screen to be checked (step S1). When the screen is a WEB page to be displayed on a typical browser, the input unit 1 acquires a HTML source. Further, the input unit 1 may acquire coordinate information, color information, and text information within the screen from the browser, for example. Both or either one of a method for acquiring screen information from a HTML source and a method for acquiring screen information from a browser may be employed.

The input unit 1 employs a typical script language function such as javascript (registered trademark) in order to acquire screen information such as coordinate information, color information, and text information within the screen. The input unit 1 can also acquire information which cannot be acquired from a HTML source or the like, such as distance between text and button and size of radio button by acquiring the screen information from the browser.

The check unit 2 acquires a check rule for consistency of a user interface from the check rule storage unit 3, and checks whether the screen information acquired from the input unit 1 conforms to the check rule (step S2). Specifically, when a different expression method or input method is found in a plurality of associated items, the check unit 2 determines an inconsistent item as an error with reference to the most common expression method or input method.

FIG. 4 is an explanatory diagram illustrating exemplary check rules. For example, when checking by use of a check rule indicated in FIG. 4, the check unit 2 checks consistency of a plurality of associated items. The check rules indicated in FIG. 4 will be described below.

The check rules indicated in FIG. 4 describe checking consistency of a layout. Specifically, there is described a check rule as to whether arrangement positions of basic operation buttons are consistent as a check item with rule number 1. For example, when “left”, “center”, and “right” coexist for the arrangements of buttons, the check unit 2 determines the fact as an error.

There is described a check rule as to whether an arrangement order of elements is consistent when the same information is displayed in a table or list as a check item with rule number 2. For example, the item names in a table are not arranged in a previously-defined order of item names, the check unit 2 determines the fact as an error.

There is described a check rule as to whether an arrangement order of buttons or menu providing the same functions is consistent as a check item with rule number 3. For example, when the buttons “OK” and “cancel” are arranged in a plurality of pages and their arrangement order is not consistent, the check unit 2 determines the fact as an error.

Further, the check rules indicated in FIG. 4 describe checking consistency of navigation. Specifically, there is described a check rule as to whether a method for displaying a current position in an application is consistent as a check item with rule number 4. For example, when a current position display method is not consistent in pages of a list of search results, the check unit 2 determines the fact as an error. For example, in a display form such as “display 20 to 40 items in 123 items”, “20 to 40 items” indicates a current position. Further, the current position display method employs breadcrumbs, for example.

Further, the check rules indicated in FIG. 4 describe checking consistency of data display parts. The items are a check rule for a method for expressing static parts such as label and text. Specifically, there is described check contents as to whether an item name expression method is consistent as a check item with rule number 5. The check unit 2 checks background color, font color, arrangement, and heading and tailing symbols of character string for the item names of a table or input/output parts, for example. The check unit 2 determines a different style from the most common style as an error.

There is described a check rule as to whether a method for expressing input mandatory/optional is consistent as a check item with rule number 6. The check unit 2 checks expressions (background color, font color, symbol indicating mandatory (such as asterisk)) of a text box as mandatory item and an item name indicating the text box are consistent.

The check rules indicated in FIG. 4 describe check contents as to whether a method of expressing a control part is consistent. The control parts are used for an interaction between a user and a computer, such as radio button and text box. When a size of the same kind of control parts or a label attached on the same kind of control parts is not consistent, the check unit 2 determines the fact as an error.

The check rules indicated in FIG. 4 describe checking consistency of a user's basic input operation. Specifically, there is described check contents as to whether an operation method (including an input method) is consistent as a check item with rule number 8. For example, when an input part whose “year/month/date” or “time” is to be input is arranged and two or more input parts with the same kind are present, the check unit 2 checks whether their input methods are the same. For example, when “YYYY/MM/DD” and “YYYYMMDD” coexist as a year/month/date input method, the check unit 2 determines the fact as an error. Further, when the functions realized by the same kind of operation method such as double click or single click a mouse, touch operation are not consistent, the check unit 2 determines the fact as an error.

The check rules indicated in FIG. 4 describe checking consistency of feedback. Specifically, there is described a check rule as to whether an information presentation method for a user operation is consistent as a check item with rule number 9. The information presentation method is a toolchip display method after mouseover, or a message display method for an input error, for example.

The check rules indicated in FIG. 4 describe checking consistency of font, term and visual expression. Specifically, there is described a check rule as to whether a method for displaying font, term and visual expression is consistent as a check item with rule number 10.

The check unit 2 checks not only consistency of a user interface of a screen but also consistency of a user interface in a plurality of screens. When each of a plurality of screens includes the same kind of user interface, the check unit 2 checks whether the user interface is consistent. For example, when a WEB site includes a plurality of screens, each screen may be made by a different developer. Also in this case, the user checks consistency of each of the screens, thereby creating a high-quality user interface.

FIG. 5 is an explanatory diagram illustrating an exemplary screen arranging two buttons thereon. FIG. 6 is an explanatory diagram illustrating another exemplary screen arranging two buttons thereon. The “CANCEL” button is arranged below the “OK” button in FIG. 5. The “CANCEL button is arranged above the “OK” button in FIG. 6. The case does not correspond to the check item with rule number 3 in FIG. 4, and thus the check unit 2 determines the fact as an error.

The display processing unit 4 displays an item not conforming to a check rule in the checking (step S3). FIG. 7 is an explanatory diagram illustrating an exemplary screen displaying a list of check results thereon. Further, the display processing unit 4 may give the links to corresponding screens in the list.

The display processing unit 4 may display a message box indicating an item not conforming to the check rule in the checking on the screen, and may display a check result within the message box. FIG. 8 is an explanatory diagram illustrating an exemplary screen displaying thereon a message box indicating an item not conforming to a check rule. The check result is an error message stored in association with the check rule in the check rule storage unit 3, for example. The display processing unit 4 uses coordinate information or the like on the screen acquired by the input unit 1 in order to determine a display position of the message box. In this way, the error message is displayed to indicate the item having a problem immediately near the item, and thus the user can easily recognize the item having a problem.

With the user-interface consistency-checking device according to the present exemplary embodiment, consistency of display and operation for a plurality of items is checked, and thus usability of an entire interface including a plurality of items can be checked.

### Second Exemplary Embodiment

FIG. 9 is a block diagram illustrating a structure of a user-interface consistency-checking device according to a second exemplary embodiment. In FIG. 9, the functions of the input unit 1, the check rule storage unit 3, and the display processing unit 4 are the same as those in the first exemplary embodiment, and thus the description thereof will be omitted.

An option setting unit 5 sets a check criterion based on user's selection. The option setting unit 5 sets a reference screen based on user's selection, for example. In this case, the check unit 2 checks by comparing other screen with the reference screen. The option setting unit 5 may set a detailed check criterion based on user's input.

The check unit 2 acquires a check rule from the check rule storage unit 3, and acquires setting contents from the option setting unit 5. The check unit 2 checks whether the screen information acquired from the input unit 1 conforms to the check rule and the check criterion set by the option setting unit 5.

The operations of the user-interface consistency-checking device according to the second exemplary embodiment will be described below. FIG. 10 is a flowchart illustrating the operations of the user-interface consistency-checking device according to the second exemplary embodiment.

The option setting unit 5 displays an option setting screen for receiving option setting for the checking, and sets a check criterion based on user's input (step S11). The option setting unit 5 sets a reference screen based on user's selection, for example. In this case, the check unit 2 checks by comparing other screen with the reference screen. The option setting unit 5 may set a detailed check criterion based on user's input.

FIG. 11 is an explanatory diagram illustrating an exemplary option setting screen. The user determines a reference screen, and when he/she wants to check by comparing other screen with the reference screen, he/she presses an automatic setting button 51 while the reference screen is being displayed. Further, when wanting to set contents to be checked, the user presses a setting button 52 of a desired item.

FIG. 12 is an explanatory diagram illustrating an exemplary check criterion setting screen. FIG. 12 illustrates a screen displayed when the setting button 52 in the sorting order of buttons is pressed in FIG. 11. For example, when three buttons with the button names of “OK”, “cancel”, and “apply” are present, for example, the user inputs the button names into the text box in an order in which he/she wants to arrange.

The input unit 1 acquires screen information for defining a user interface of a screen to be checked (step S12). The processing in step S12 is the same as the processing in step S1 in FIG. 2.

The check unit 2 acquires a check rule for consistency of a user interface from the check rule storage unit 3, and acquires setting contents from the option setting unit 5. The check unit 2 checks whether the screen information acquired from the input unit 1 conforms to the check rule and the check criterion set by the option setting unit 5 (step S13).

For example, when checking by comparing other screen with the reference screen, the check unit 2 compares a screen to be checked with the reference screen with respect to the check items such as button position, text contents, and color of background or characters. Further, when the user sets a check criterion in detail, the check unit 2 checks the screen based on the criterion.

The display processing unit 4 displays an item not conforming to the check rule in the checking (step S14). The processing in step S14 is the same as the processing in step S3 in FIG. 2.

With the user-interface consistency-checking device according to the present exemplary embodiment, the user can freely customize a check method, thereby checking a screen at user's will.

### Third Exemplary Embodiment

FIG. 13 is a block diagram illustrating a structure of a user-interface consistency-checking device according to a third exemplary embodiment. As illustrated in FIG. 13, the user-interface consistency-checking device according to the present exemplary embodiment includes a batch execution unit 6 and a user-interface consistency-check unit 10. A structure of the user-interface consistency-check unit 10 is the same as the structure described according to the first exemplary embodiment, and thus the description thereof will be omitted.

When a predetermined condition is met, the batch execution unit 6 causes the user-interface consistency-check unit 10 to perform a processing on a file describing therein a program for realizing a screen to be checked. The batch execution unit 6 causes the user-interface consistency-check unit 10 to perform a processing on screen information described in a source file such as HTML. Alternatively, the batch execution unit 6 may automatically display a screen to be checked, may cause the operations such as login and text input to be automatically performed, and may cause the user-interface consistency-check unit 10 to perform a processing on the screen.

The operations of the user-interface consistency-checking device according to the present exemplary embodiment will be described below. FIG. 14 is a flowchart illustrating the operations of the user-interface consistency-checking device according to the present exemplary embodiment. The series of processing in step S23 to step S25 are the same as the series of processing in step S1 to step S3 according to the first exemplary embodiment, and thus the specific description thereof will be omitted.

At first, the user sets for the batch processing (step S21). Specifically, the user sets where a program file (such as HTML) for realizing a screen to be checked is to be stored. Further, the user sets a time to perform the batch processing.

When a preset time comes (YES in step S22), the batch execution unit 6 causes the user-interface consistency-check unit 10 to perform a processing on the program file for realizing a screen to be checked (step S23 to step S25). The batch execution unit 6 may cause the user-interface consistency-check unit 10 to perform a processing not only when a set time comes but also when a program file is newly updated or in response to a user's operation.

### Examples

FIG. 15 is an explanatory diagram illustrating an exemplary batch processing. The user stores a source file such as HTML in a repository in a server from a client PC (Personal computer). When a preset time comes, the batch execution unit 6 then causes the user-interface consistency-check unit 10 to perform a processing on the program file for realizing a screen to be checked. In the example illustrated in FIG. 15, the check unit 2 checks by use of only a source file without actually displaying a screen, and thus executable program files are limited. For example, the checking by the check unit 2 can be performed on HTML but cannot be partially performed on jsp, php, cgi, and the like.

FIG. 16 is an explanatory diagram illustrating another exemplary batch processing. The user stores a source file such as HTML in a repository in a server from a client PC. When a preset time comes, the batch execution unit 6 then causes a simulated processing unit 20 in the server to deploy a screen to be checked. An automated test tool disclosed in NPL 2 is employed for deploy, for example. Specifically, the simulated processing unit 20 in the server automatically displays a screen to be checked, and automatically performs the operations such as login and text input. The batch execution unit 6 then causes the user-interface consistency-check unit 10 to perform a processing by use of the program file for realizing a screen to be checked and the screen information acquired from the displayed screen.

In the example illustrated in FIG. 16, the screen is actually displayed to be checked, and thus the check unit 2 can check all the screens like when the user manually checks.

The user-interface consistency-check unit 10 according to the present exemplary embodiment may include the option setting unit 5 described according to the second exemplary embodiment. In this case, the user needs to perform option setting prior to batch execution.

With the user-interface consistency-checking device according to the present exemplary embodiment, for example, when the user sets the batch processing to be performed during nighttime everyday, he/she can easily know problematic points on daily-varying screens in a developing stage. Further, with the user-interface consistency-checking device according to the present exemplary embodiment, the user can omit his/her own checking.

FIG. 17 is a block diagram illustrating a structure of main components in a user-interface consistency-checking device according to the present invention. There are provided the input unit 1 for acquiring screen information on a screen to be checked, the check unit 2 for checking consistency of a user interface of the screen based on a previously-defined check rule, and the display processing unit 4 for displaying an item not conforming to the check rule.

Each exemplary embodiment discloses the user-interface consistency-checking device described in the following (1) to (9).

(1) A user-interface consistency-checking device in which when each of a plurality of screens includes the same kind of user interface, a check unit (the check unit 2, for example) checks whether the user interface is consistent.

(2) The user-interface consistency-checking device may be configured such that the check unit checks consistency of a layout.

(3) The user-interface consistency-checking device may be configured such that the check unit checks consistency of a current position display method in an application.

(4) The user-interface consistency-checking device may be configured such that the check unit checks consistency of a static part expression method.

(5) The user-interface consistency-checking device may be configured such that the check unit checks consistency of a control part used for an interaction between a user and a computer.

(6) The user-interface consistency-checking device may be configured such that the check unit checks consistency of a user input operation method.

(7) The user-interface consistency-checking device may be configured such that the check unit checks consistency of an information presentation method for a user's operation.

(8) The user-interface consistency-checking device may include an option setting unit (the option setting unit 5, for example) for setting a check criterion based on user's selection, and may be configured such that the check unit checks screen information based on a check rule and a check criterion. With the user-interface consistency-checking device, the user can freely customize a check method, thereby checking a screen at user's will.

(9) The user-interface consistency-checking device may include a batch execution unit (the batch execution unit 6, for example) for, when a predetermined condition is met, causing an input unit (the input unit 1, for example), a check unit (the check unit 2, for example), and a display unit (the display processing unit 4, for example) to perform a series of processing. With the user-interface consistency-checking device, the user can omit his/her own checking.

The present application claims the priority based on Japanese Application No. 2013-056651 filed on Mar. 19, 2013, the disclosure of which is all incorporated herein by reference.

The present invention has been described above by way of the exemplary embodiments and the example, but the present invention is not limited to the exemplary embodiments and the example. The structure and details of the present invention can be variously modified within the scope of the present invention understandable by those skilled in the art.

### INDUSTRIAL APPLICABILITY

The present invention is applicable to check usability of a user interface of a WEB site.

### REFERENCE SIGNS LIST

1 Input unit

2 Check unit

3 Check rule storage unit

4 Display processing unit

5 Option setting unit

6 Batch execution unit

1. A user-interface consistency-checking method comprising:
acquiring screen information on a screen to be checked;
checking consistency of a user interface of the screen based on a previously-defined check rule; and
displaying an item not conforming to the check rule.

2. The user-interface consistency-checking method according to claim 1, comprising:
when each of a plurality of screens includes the same kind of user interface, checking whether the user interface is consistent.

3. The user-interface consistency-checking method according to claim 1, comprising:
checking consistency of a layout.

4. The user-interface consistency-checking method according to claim 1, comprising:
checking consistency of a current position in an application.

5. The user-interface consistency-checking method according to claim 1, comprising:
checking consistency of a static part expression method.

6. The user-interface consistency-checking method according to claim 1, comprising:
checking consistency of a control part used for an interaction between a user and a computer.

7. The user-interface consistency-checking method according to claim 1, comprising:
checking consistency of a user input operation method.

8. The user-interface consistency-checking method according to claim 1, comprising:
checking consistency of an information presentation method for a user operation.

9. The user-interface consistency-checking method according to claim 1, comprising:
setting a check criterion based on user's selection; and
checking screen information based on a check rule and the check criterion.

10. The user-interface consistency-checking method according to claim 1, comprising:
when a predetermined condition is met, performing a screen information acquisition processing, a screen check processing, and a check result display processing.

11. A user-interface consistency-checking device comprising:
an input unit for acquiring screen information on a screen to be checked;
a check unit for checking consistency of a user interface of the screen based on a previously-defined check rule; and
a display processing unit for displaying an item not conforming to the check rule.

12. The user-interface consistency-checking device according to claim 11,
wherein when each of a plurality of screens includes the same kind of user interface, the check unit checks whether the user interface is consistent.

13. A non-transitory computer readable information recording medium storing a user-interface consistency-checking program that, when executed by a processor, performs a method for:
acquiring screen information on a screen to be checked;
checking consistency of a user interface of the screen based on a previously-defined check rule; and
displaying an item not conforming to the check rule.

14. The non-transitory computer readable information recording medium storing a user-interface consistency-checking program according to claim 13, the program that, when executed by a processor, performs a method for:
when each of a plurality of screens includes the same kind of user interface, checking whether the user interface is consistent.

15. The user-interface consistency-checking method according to claim 2, comprising:
checking consistency of a layout.

16. The user-interface consistency-checking method according to claim 2, comprising:
checking consistency of a current position in an application.

17. The user-interface consistency-checking method according to claim 3, comprising:
checking consistency of a current position in an application.

18. The user-interface consistency-checking method according to claim 2, comprising:
checking consistency of a static part expression method.

19. The user-interface consistency-checking method according to claim 3, comprising:
checking consistency of a static part expression method.

20. The user-interface consistency-checking method according to claim 2, comprising:
checking consistency of a control part used for an interaction between a user and a computer.
